(19) United States
(12) Patent Application Publication
(10) Pub. No.: US 2012/0203689 A1
(43) Pub. Date: Aug. 9, 2012

(54) Real-Time Account Communication

(76) Inventor: Joseph Parvis, Highlands Ranch, CO (US)

(21) Appl. No.: 13/370,261

(22) Filed: Feb. 9, 2012

Related U.S. Application Data
(60) Provisional application No. 61/441,233, filed on Feb. 9, 2011.

(51) Int. Cl. G06Q 40/00

(52) U.S. Cl. 705/39; 705/35

(57) ABSTRACT

Embodiments of the invention describe a near real-time account messaging system using the ISO 8583 protocol and 0600 administrative message type for sending configurable notification messages to clients based on defined triggers activated by events, or transactions, occurring on an account. The account can be registered with the account messaging system and with the client system. The client is not a participant within the event causing the notification message to be generated and sent to that client.

### CROSS-REFERENCE TO RELATED APPLICATIONS

This application is a non-provisional of and claims benefit of the filing date of U.S. provisional patent application No. 61/441,233, filed on Feb. 9, 2011, which is herein incorporated by reference in its entirety for all purposes.

### BACKGROUND

In the present day transaction processing infrastructure, a user conducts a transaction with a merchant and the user's transaction details and account information are processed through a payment processing network. The network performs authorization and settlement with an issuer of the account. The transaction may be processed in real-time, but a client account may not be updated until the end of the day. This is because the payment processing network, including acquirers, card associations, card program managers (e.g., clients), and issuers, are provided with a one a day batch report including the updates to accounts associated with each entity. Accordingly, if a user has, for example, a prepaid card or debit card, the user may not be able to utilize the account associated with the card until funds loaded to the card and/or returned to the card are updated in the account balance the next day. In some cases, such as with checks associated with an account, the debit and/or credit amount is not seen for multiple days.

For some merchants, conducting transactions with accountholders over reliable and fast networks, such delay in the report processing may not be a factor. Similarly for accountholders having additional funding on credit cards having higher balances, such delay in processing funding on that card may not be a factor. However, for merchants conducting transactions over networks which are not always “on-line” and for accountholders requiring immediate funding available on accounts having a prepaid balance, the daily batch reports and account updates do not suffice.

What is needed is a system to support more effective program management for the program managers of card programs such that account information is received in near real-time as transactions are conducted on an account. It would also be desirable to provide such account information to an entity not involved in the transaction processing network, so that the entity can perform further processing. Embodiments of the invention address these and other problems, individually and collectively.

### BRIEF SUMMARY

Embodiments of he present invention provide near real time account communication to a client based on events occurring on the account and triggered within an account processing system, such as a debit or prepaid account system. In some embodiments, utilizing the ISO 0600 format for a notification message including the account and event information, the notification messages can be communicated to the client in near real time and in response to a transaction being conducted on an account in a payment processing network.

The ISO 8583 0600 format is traditionally used for administrative messages, such as notes being passed between entities involved in a transaction. Since the ISO 0600 messages are an informational exchange type message, rather than a transactional information message, e.g., 0200, the messages themselves are not transactional and they can allow the account processing system to communicate account information to the client along with other transaction details in order to maintain a database on the client side with updated account information. Accordingly, various amounts of information regarding the account can be passed to the client, who is not involved in the transaction, in order for that client to locally store and utilize that information in whichever manner desired. Because there is no limitation to the amount of account information provided in the message to the client, the client can define the information desired in the message through configuration settings on the account processing system.

The account information being sent in the notification message can include accountholder events and transactions, balance changes, cardholder events and other changes to the state of the account. With updated account information, the client can perform many functions on the account, such as offline transactions and sending alerts based on account balance changes or declined transactions. The notification messages, including the near real time account updates, can be generated in response to triggers comprising account events and financial events, each of the events can be referred to as transactions occurring on an account. For example, account event triggers can include status or state change, user profile change, and maintenance functions. Financial event triggers can include, for example, available balance change and declined transaction. The notification messages sent in response to the transaction events do not drive the originating event, but can allow for the client to perform transactions, e.g., further events, on the account locally with the information received in the notification message.

In one embodiment of the invention, a method for real time account communication to a client computer is provided. The method includes detecting an event occurring on an account within an account database, analyzing the event with respect to a trigger, generating a notification message in a first format, and sending the notification message to the client computer through a client processor interface. The event is detected on an account processing server computer. The event results in a change in a current state of the account. The notification message is generated by the account processing server computer. The client computer is operated by a client that is not a participant in the event. The notification message is sent in substantially real time with respect to the event.

In further embodiments, the first format defines a message type having a particular structure. In one embodiment, the notification message is in ISO 8583 0600 format. In another embodiment, the notification message includes a plurality of data fields, and wherein a specific data field is paired with the trigger dependent on a trigger type. In yet another embodiment, the event occurs in response to a financial transaction being conducting on the account. In some embodiments, the trigger includes a change in the balance within the account. In other embodiments, the trigger includes a declined transaction. In another embodiment, the event occurs in response to a non-financial transaction on the account. In some embodiments, the trigger for non-financial transactions include any one or more of a change to a current status of the account, an update to a user profile on the account, or a maintenance function performed on the account.

In further embodiments, the method includes receiving a first communication from the client computer, and the first communication includes the event. In yet a further embodiment, the notification message includes account information with details relating to the event and to the current state of the account. In another embodiment, the client computer stores the account information in a client account database and utilizes the stored account information to conduct an off-line transaction on the account. In one embodiment, the client computer utilizes the stored account information on the client account database to generate an alert for a user associated with the account. In an embodiment, the method also includes receiving a confirmation message from the client computer. The confirmation message is received at the account processing server. The confirmation message is sent through the client processor interface computer.

Another embodiment of the invention provides an account processing server computer including a processor and a computer readable medium coupled to the processor. The computer readable medium can include code executable by a processor for implementing the aforementioned method and embodiments.

These and other embodiments of the invention are described in further detail below.

### BRIEF DESCRIPTION OF THE DRAWINGS

FIG. 1 illustrates a block diagram of data flow in real-time account communication between an account processor server computer and a client computer, according an embodiment of the invention.

FIG. 2A illustrates an exemplary system that can be utilized to implement real-time account communication shown in FIG. 1, in an embodiment of the invention.

FIG. 2B illustrates a block diagram of an exemplary transaction processing network in FIG. 2A, in an embodiment of the invention.

FIG. 3 illustrates an exemplary flowchart showing operations for enabling control setting for a trigger within the real-time account communication implemented in the system of FIG. 2A, in an embodiment of the invention.

FIG. 4 illustrates an exemplary screenshot of a notification message report for a particular client system in an embodiment of the invention.

FIG. 5 illustrates an exemplary formatted notification message that can be generated by the account processing server in FIG. 2B, according to an embodiment of the invention.

FIG. 6 illustrates an exemplary raw notification message that can be generated by the account processing server in FIG. 2B, according to an embodiment of the invention.

FIG. 7 illustrates a flow diagram of operations involved in providing real-time account communication on an account processing server computer, according to an embodiment of the invention.

FIG. 8 illustrates a block diagram of a computer apparatus that may be used to implement the real time account communication techniques in FIG. 2A, in an embodiment of the invention.

### DETAILED DESCRIPTION

Embodiments of the present invention are directed to a system and method for providing notification messages to a third party, e.g., a client, in response to an event occurring on an account within an account database. The event can be a change in a current state of the account, which can be analyzed with respect to a plurality of triggers in order to generate a notification message associated with a particular trigger type. Each trigger type can be defined by the particular state change in the account, such as a balance change on the account. Event can be transactional, such as a financial transaction occurring on the account balance, or a maintenance transaction occurring to update a user profile on the account.

The notification message can be generated on an account processing server computer associated with the transaction, or payment, processing network. In some embodiments, the notification message is generated in a particular format, which can be supported on both the client side and the account processor side through a processor interface. The message can be communicated in near real time, in response to the event occurring. Accordingly, each client receiving the notification message in response to a particular event can update their systems with the most recent details for the account. This allows each client to be able to interact with a particular accountholder without requiring the client to conduct a full transaction through the transaction processing network, e.g., the client can communicate “off-line” or via local communication with the accountholder.

Various terms utilized to describe the present invention are defined within the following paragraphs. Though described with reference to particular embodiments, the following descriptions are not limited those embodiments and may encompass various other embodiments within the scope of the present invention.

An “account” as used herein includes a financial account, such as a bank account, prepaid card account, credit card account, debit card account, checking account, etc., that is associated with at least one user, e.g., account holder or cardholder. A single account can be associated with multiple users, though a particular user of the account can be the executor on the account.

An “account processor” as used herein is the system including at least the account database and the account processing server computer, which is capable of receiving a communication through a transaction processing network, generating a triggered notification message in response to an event occurring on an account and sending the notification message to at least one client. In some embodiments, the account processor sends the notification message to multiple recipients, such as the account holder, a plurality of clients, a merchant, and/or a mobile device associated with the account holder.

An “account processing server computer” as used herein indicates a computer or cluster of computers. For example, the server computer can be a mainframe, a minicomputer cluster, or a group of servers functioning as a unit. In one example, a server computer may be a database server coupled to a Web server. Data transfer and other communications between components such as computers may occur via any suitable wired or wireless network, such as the Internet or private networks.

A “computer” as used herein refers to a system comprising a processor and a computer readable medium, such as computer memory or other data storage device, coupled to the processor. The computer readable medium stores code executable by the processor. For example, the computer can include the client computer as described within the present invention.

A “account database” can include a memory storage devices, such as a random access memory (RAM), capable of storing user accounts, account information, transaction details associated with an account and user profile information associated with those accounts. Information stored on the database can be modified and erased.

A “first format” as used herein defines a message type having a format and/or structure of the outgoing near real-time message sent to the client. This may be a specific ISO 8583 message type (e.g. 0600), an MQ message format (e.g., WebSphere), an external web services (e.g., SOAP) message format, or any other message protocol selected and defined by the account processor and the client. Accordingly, though ISO message type is described in the implementation of the invention discussed in the following description, any message type could be utilized within the invention which is capable of being read and securely sent (e.g., via push messaging) between the account processing server and the client.

“Near real-time” or “substantially real time” account communication as used herein describes the time period allotted for a notification message to be generated and sent to a client. Near real time account communication can be, for example, less than about 5 minutes, less than about 1 minute, or within 30 seconds of an event occurring. For example, if a user performs a purchase transaction, a notification message may be sent from the account processing server computer to a client computer within thirty (30) seconds of the transaction being recorded by the account processor system. Exceptions to the less than thirty (<30) second standard processing can arise if systems or sub-systems become unresponsive, or, if the system is clearing a large backlog.

“Processor interface” or “PI” as used herein describes the account processor system component which formats, sends, and receives notification messages from the account processor system (the ‘internal PI’) or from the client (the ‘client PI’). The core transaction processing system communicates with the account processor and the clients through processor interfaces.

A “notification message” as used herein is a combination of a message type in a first format and the usage of that message. Accordingly, a notification message defines the message type and the specific data elements defined as a usage of that message type.

“Usage” as used herein is a set of data elements for a particular message type. A single message type can have multiple usages.

“Transaction” as used herein is any valid action with a transaction category, transaction type, and qualifiers. Transactions include both approved and declined, non-financials, and fees. Transactions do not necessarily affect the card balance. Transactions may have an associated fee, and this can be set to zero. Zero dollar fees are considered transactions in and of themselves.

“Trigger” as used herein is an occurrence of a defined event in the account processing system. Such events include a change in a data element associated with a payment device, e.g., a prepaid card or account, user(s), buyer, or gift giver. Note that from the user's perspective a single ‘action’ may activate multiple triggers in the system. For example, a user may perform a balance inquiry. This action can produce two distinct events (and triggers) in the account processing system: 1) the balance inquiry itself, and 2) any associated fee transaction, if configured for a particular card program.

A “Client” may include a program manager for a payment card, such as any entity which is capable of managing the accounts associated with a particular account type. The clients can include issuing and acquiring banks, and third-party program managers, any of whom may manage client-side or offline systems for transaction processing, messaging to account holders, or other account information management. Examples include, but are not limited to: transportation management companies assessing and validating transit access in an offline environment, third party program managers controlling messaging and account alerts to account holders, financial institutions maintaining and synchronizing customer information databases for purposes of fraud and compliance, and other account holder management. In further embodiments, client examples can include: network-branded travels cards, money and financial service cards, network-branded gift cards, remittance and peer to peer networks, open-loop events and meetings, open-loop employee and partner incentives, open-loop consumer incentives, open-loop campus, open-loop in-store gift cards, open-loop social security disbursement, open-loop TANF and WIC disbursements, open-loop court ordered payments, open-loop transit, state unemployment, insurance cards, payroll cards, open-loop benefits cards, and FSA/HAS cards.

Exemplary Systems

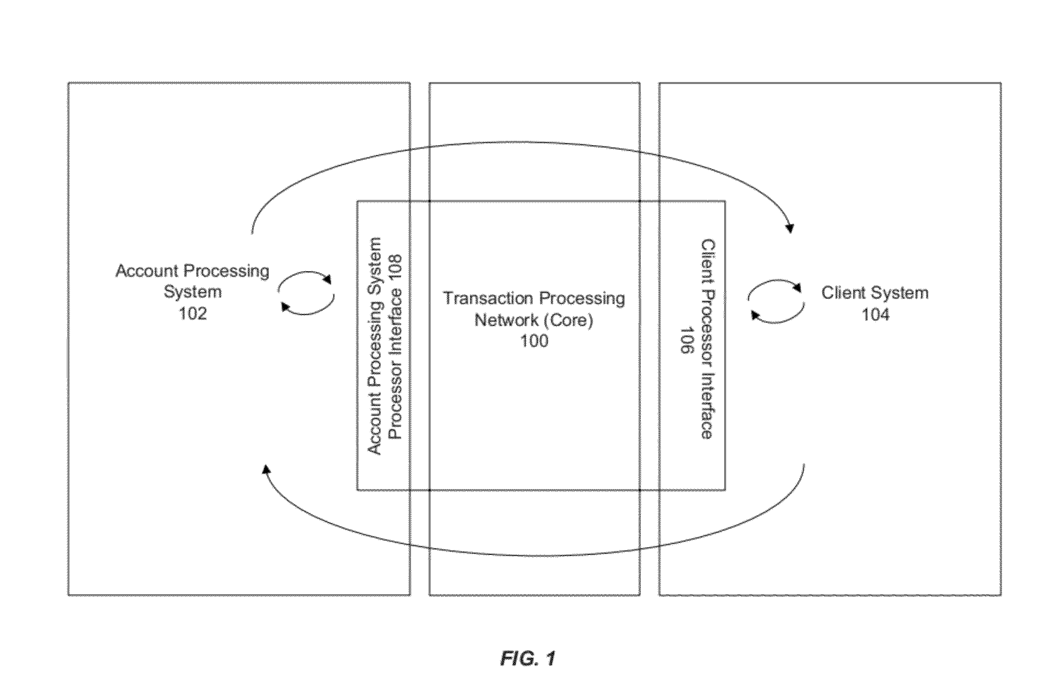

Referring now to FIG. 1, a block diagram of the data flow within the real time account communication system, including the account processing system 102, transaction processing network (core) 100 and client system 104 is shown. In some embodiments, the account processing system 102 can be associated with an issuer system, such a debit processing sub-system. In other embodiments, the account processing system 102 can be associated with the transaction processing network 100, such as a payment processing network, or can be a third party service provider in communication with at least the core 100 and client system 104. The communication system, which can include the core 100, client system 104 and account processing system 102, can utilize near real time account communication, implementing ISO standard messaging functionality. In particular, the communication system can implement ISO 8583 0600 messaging, in some embodiments.

Client systems 104 can establish connectivity with the account processing system 102 through a client processor interface 106, which acts as gateway through which ISO messages and be sent and received. The messages, referred to hereafter as notification messages, are initiated by the transaction processing network 100 and are passed outbound to the client system 104, utilizing a processing network side processor interface 108, which can also be installed with the client system, e.g. the client processor interface 106. Both inbound and outbound messages are formatted in a first format, such as the ISO 8583 protocol with the 0600 administrative message type. The notification message flow relies on return ISO messages confirming receipt. In some embodiments, repeat notification messages are sent to the client system 104 and back to the account processing system 102 until confirmation is received from the originating system.

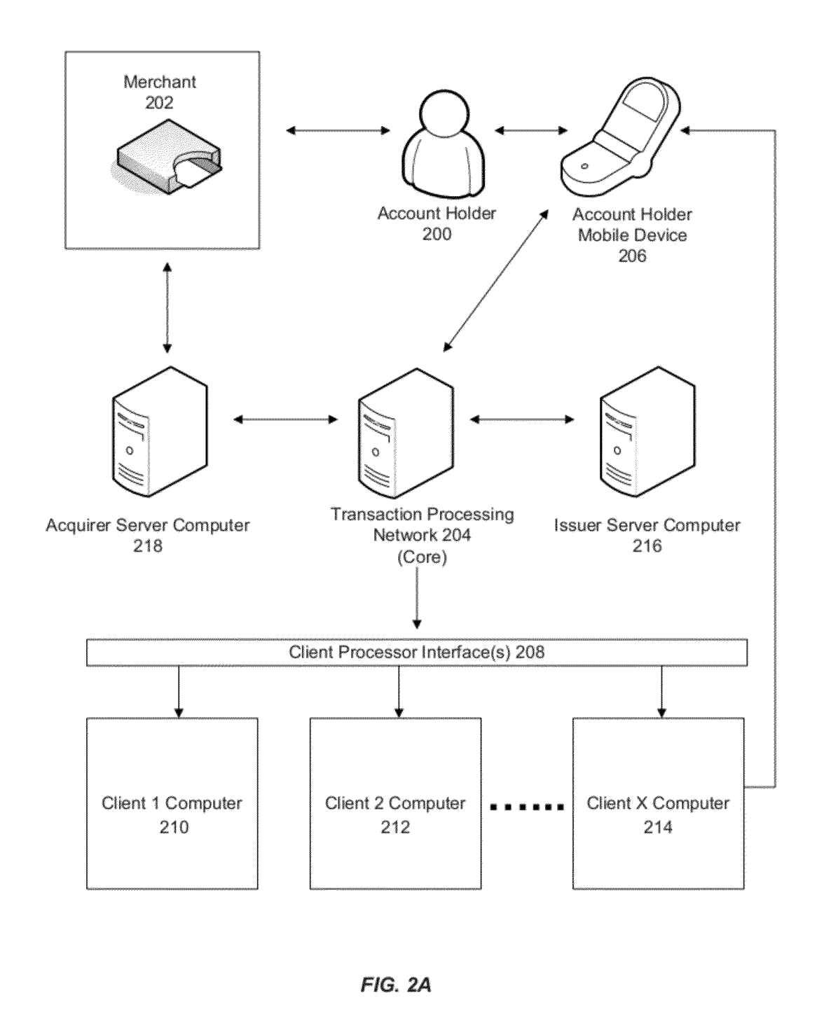

Referring now to FIG. 2A, a functional block diagram of the real time account communication system in FIG. 1 is illustrated in an embodiment. In such an embodiment, an accountholder is shown conducting a transaction at a merchant location, such as by swiping a payment device in a card reader. The card reader can be coupled to a merchant register (not shown), such as a computer, which can be coupled to the network through a hard-wired or wireless connection. The payment device can be associated with an account on the account processing system's account database (shown in FIG. 2B). The account processing system can be associated with and in communication with the transaction processing network. In some embodiments, the account processing system is a part of the transaction processing network. In other embodiments, the account processing system is associated with a particular issuer, such as a bank.

Once the accountholder's payment device is read by the access device, or card reader at the merchant location, the transaction can be processed similar to a normal transaction. The transaction details and account information are communicated to an acquirer 218, or authorization clearing house (ACH), in an authorization request message. The acquirer 218 then forward the authorization request message to a payment processing network, such as the transaction processing network (core) 204 shown in FIG. 2A. The core 204 can communicate with an issuer 216 to authorize the transaction and provide an authorization response message to the merchant, e.g., through the acquirer 218 to complete the transaction. Additionally, the core 204 can communicate the transaction details and account information to the account processing system (shown and described in FIG. 2B) at substantially the same time as requesting authorization with the issuer. The account processing system generates notification messages based on the transaction details and account information, which are communicated via the core 204 to the client computers, such as client 1 computer 210, client 2 computer 212 and client X computer 214.

Each of the client computers 210, 212, 214, can be communicatively coupled to a client processor interface 208, which allows the client computers to transmit messages to the transaction processing network 204 in a first format and processes messages from the transaction processing network 204 such that the messages can be readable by the client computer. As shown in FIG. 2A, a single client processor interface 208 is coupled to each of the client computers in one embodiment. Such implementation can be done through a client plug-in. In further embodiments, each individual client system, e.g., client computer and associated database, etc., includes a client processor interface for communicating with the core 204.

Once a notification message, generated in response to the transaction occurring on the accountholder 200 account, is received by a client computer 210, 212, 214, the client can utilize the transaction details and account information to perform various functions on the account. For example, the client can store and internally update client records, e.g., with the account information, on a local client database (not shown), which is part of the client system. The client can track usage patterns of the accountholder 200 based on each transaction performed on the account. In further embodiments, the client can send alerts and/or messages to the accountholder 200, indicating particular details of the account and/or transaction, e.g., “Your account balance is low” or “Transaction charged $20 to account ending in x0000”. The client can send such alerts to an accountholder mobile device 206, e.g., if the device is registered with the account on the client database.

In further embodiments, the transaction processing network (core) 204 can additionally send alerts and/or other messages to the accountholder 200, when a transaction is processed. For example, the core 204 can send an alert to the accountholder mobile device 206, e.g., via a mobile application executed on the accountholder mobile device 206, each time a transaction is processed through the core 204. This alert may differ from an alert received from the client and/or provide similar information, indicating particular details of the account.

Referring now to FIG. 2B, an expanded view of the transaction processing network (core) 204 in FIG. 2A is shown. The core 204 can be embodied by one or more server computers, having various applications residing on the one or more server computers for processing transactions and generating messages including transaction details for various systems coupled to the core 204. The core 204 can include data processing subsystems, networks, and operations used to support and deliver authorization services, exception file services, and clearing and settlement services, and alert services. The core 204 can be able to process payment card transactions, debit card transactions, and other types of commercial transactions. The core 204 can also process authorization requests and may include a Base II system, which performs clearing and settlement services. In an embodiment of the invention, the core 204 can provide other value added services, such as fraud determination, benefit points, and notifications to third party systems, such as the clients systems 210, 212, 214 shown in FIG. 2A.

The core 204 can include a network interface 234, for communicating with various systems through any suitable wired or wireless network, such as the Internet. The core 204 can further be communicatively coupled to any number of issuers 216 (FIG. 2A) through the network interface 234. Each issuer 216 may provide payment accounts for the accountholder to purchase goods or services, such as accounts associated with the payment accounts stored on the client system.

The core 204 can additionally include a central server computer, such as transaction processing sever computer 220, and a database 238 associated with the server computer 220 for storing account information and transaction data. The transaction processing server computer 220 can additionally include a processor 240 and a computer readable medium 242. The computer readable medium can comprise code or instructions for performing various functions of the transaction processing network (core) 204. Accordingly, the computer readable medium 242 can include various modules, which utilize instructions stored on the computer readable medium 242 to perform specific functions of the transaction processing network (core) 204. For example, the transaction processing sever computer 220 can include an account verification module 220, which can include an account verification engine for verifying the account on the database 238. If the account is not verified on the database, the transaction can be declined and core 204 can return and “declined” authorization response message to the merchant.

The transaction processing server computer 220 can also include an authorization module, which can generate authorization request messages, including the verified account information, to an issuer for authorization of a transaction. A settlement module 224 can perform settlement with the issuer of the account, and an alert module 226 can generate alerts to the accountholder, e.g., through a registered accountholder mobile device as shown in FIG. 2A.

The transaction processing network (core) 204 can additionally include various subsystems for processing various types of transactions. For example, the transaction details can also be communicated to an account processing system 228, through a processor interface 236, similar to the client processor interface 208 shown in FIG. 2A. The processor interface 236 of the account processing system 228, transmits and processors the incoming and outgoing messages in the first format. The account processing system 228 can be a subsystem of the core 204, of an issuer server computer 216, or can be a standalone system communicatively coupled to at least the issuer, for receiving account information and updates.

An account processing server computer 230 can check the account information with the accounts stored on an associated account database 232 in order to determine if the account on which the transaction is being conducted is enrolled in the account processing system 228 service. The account processing server computer 230 is configured to communicate with the account database 232 to retrieve account information and other criteria associated with accounts of various accountholders.

In some embodiments, the account information passed along with the transactions details can include an additional data elements, indicating whether the account is enrolled in the account processor service and registered on the account database. If the account is not registered, no further action is performed with the account processing system and the transaction is processed through a normal clearing and settlement process conducted by each of the payment processing networks, such as the core 204. A clearing process is a process of exchanging financial details between an acquirer 218 and an issuer 216 to facilitate posting to the payment accountholder's account and reconciliation of the consumer's settlement position. Clearing and settlement can occur simultaneously.

If the account is registered, the transaction details are passed through the account processing system 228 to determine if the transaction, e.g., an event on the account, triggers a response in the form of a notification message. Specific criteria, defining the triggers, are stored in the account processing system 228. Once an event occurs on the account, e.g., a transaction is conducted (financial or non-financial), the criteria for a trigger can be satisfied, causing an automatic response to be generated in the system 228. The response can be generated in the form of a notification message, which includes specific information (e.g., data set) relating to a particular trigger. In some embodiments, the notification message can include similar information for all triggers, such as the transaction details for the event occurring on the account and the current account information on the account database 232.

There are various triggers available to initiate the notification messages. The triggers can be configured by clients, e.g., during registration with the account processing system 228. The triggers can be based on which events in the account processing system 228 for which the clients would like real-time updates to update and maintain client side records, as well as identifiers to call further information through other communication protocols, such as External Web Services. Depending on the various usages, different data sets are sent within the different notification messages, including the order and structure of individual data elements within the notification message. The notification message is then sent through the processor interface 236 to the client computer 210, 212, 214 as shown in FIG. 2A, formatted according the processor interface 236 configuration.

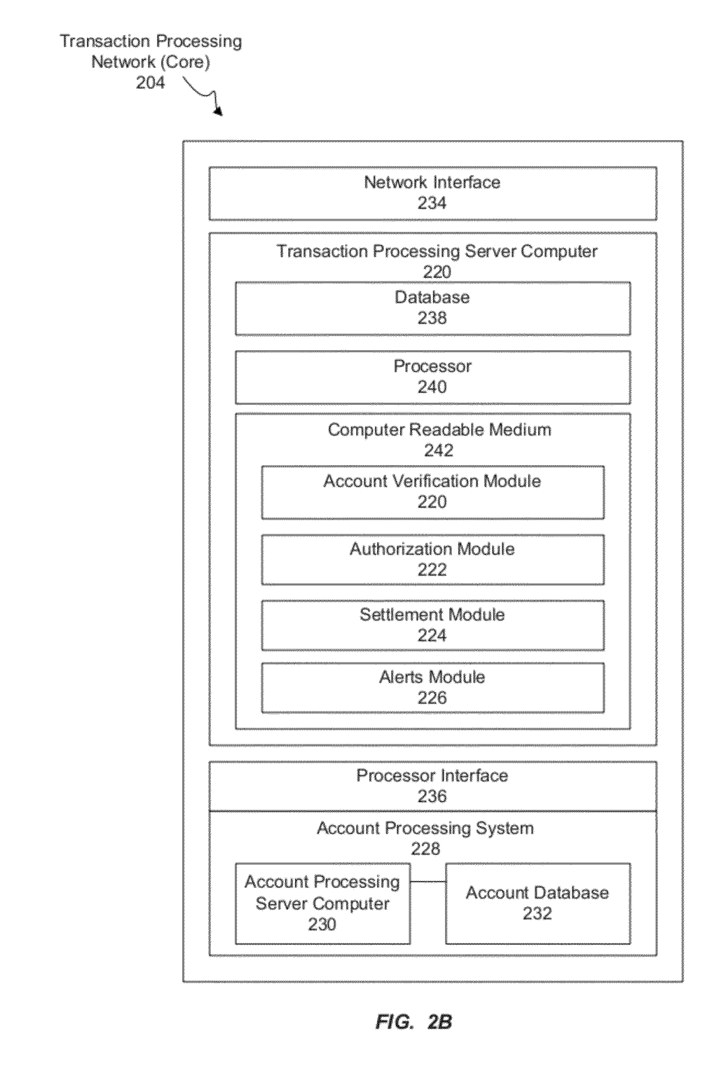

Referring now to FIG. 3, an exemplary flowchart for enabling the operation of a trigger is shown in an embodiment. In some embodiments, clients are able to configure one or more triggers for each usage, which may be inherited at a sub-client level unless overridden. For example, a data set containing data elements such as, for example: user alias ID, primary card alias ID, card number, transaction category, transaction type (e.g., debit or credit), total surcharges and fees, transaction amount and other transaction details. The data set can be associated with a particular usage ID, which determines the data elements and structure of the notification message, and can be configured by a client to be utilized with a first trigger and with a second trigger. In some embodiments, a trigger can have only one usage ID. In other embodiments, a trigger can be associated with multiple usage IDs. Accordingly, if either trigger 1 or trigger 2 is initiated for an event on the account, the client receives the same data elements. Essentially, a client can define which information is provided in the notification message for each trigger type. In an embodiment, trigger configurations can be overridden at the sub-client level.

Initially, a default configuration can be implemented by the account processing system 228. For example, the notification messages can be set to an “Off” position until a client configures the triggers and initializes those triggers in the account processing system 228.

Exemplary triggers in accordance to embodiments of the invention are discussed in the following paragraphs.

A first trigger can include an available balance change, such as when an accountholder conducts a transaction at a merchant location and a current balance in the account is lower and/or higher (e.g., a return of a purchase to a merchant) than a previous balance. Clients can configure the available balance change trigger for near real-time updates reflecting changes to available balance. The account processing system 228 can create and send a notification message for each event on the account, such as a prepaid account or debit card account, which results in a change of available balance. This may include, for example, the aforementioned transaction occurring at a merchant location or a re-load of a payment card associated with a prepaid account.

As previously mentioned, the account balance change can be either positive or negative. A threshold can be set for the account balance change trigger to be activated and for the notification message to be sent. When the available balance change trigger is configured, any change in the balance can cause the account processing system 228 to generate and send a notification message. This includes the initial available balance added when an account is created. For example, for a prepaid payment card, the account balance change trigger can be activated from purchase or initial load of the prepaid card.

In some embodiments, accounts can have multiple accountholders associated with a single account. For example, a single debit account can include two or more joint accountholders, each accountholder having a payment card with a unique card number being linked to that account. The primary accountholder can be assigned a user alias identification (ID) and a primary card alias ID, which are associated with the primary accountholder. The other accountholders associated with the account, e.g. the joint accountholders, are also each assigned a unique user alias ID. When a card has multiple accountholders and when an available balance change occurs on, for example, a single stored value account (SVA), such as a prepaid or debit account, notification messages can be sent for each accountholder payment card linked to the stored value account. In the notification message for the primary accountholder, the user alias ID is the user alias ID assigned to the primary accountholder, and the primary card alias ID is also the primary card alias ID assigned to the primary accountholder. In the notification message for the joint accountholders, the user alias ID is the user alias ID assigned to each joint accountholder, and the primary card alias ID is the card alias ID assigned to the primary accountholder.

For a single transaction event (e.g., a retail purchase), the account processing system 228 may send only one notification message, even if that transaction has one or more fees or surcharges associated with it that also affect the account balance. The single notification message can contain the transaction details for the triggering transaction as well a listing of the total amount of fees and the total amount of surcharges for the transaction, if any. The available balance reported in the notification message can be the balance after the transaction charges and all fees and surcharges are considered.

In further embodiments, if a transaction with an available balance change trigger causes a non-transactional change (such as a change in state) trigger, multiple notification messages can be generated and sent, one for each trigger activated by the transaction. The notification message for the available balance change can include both the balance change and the transaction usage as configured by the client for the account balance change trigger. The notification message can be communicated to the client system, e.g. the client server computer, using a first format, such as the ISO 0600 protocols, and the processor interfaces as described within reference to FIG. 1.

Another client configurable trigger can include a declined transaction, such as when the issuer of the account has indicated insufficient funds available for the account and/or the account is on “hold” or is “closed”. The account processing system can create and send a notification message for any declined transaction, except when the client control setting for the declined transaction trigger is set to “Yes” and the accountholder profile control setting is set to “Off.”

When a declined transaction occurs for a payment device, such as a prepaid card, associated with a stored value account (SVA) having multiple users (Joint Users), notification messages can be sent for each payment device, e.g., card, associated with the stored value account. The stored value account can have primary accountholder or user, such as a user that created the account, or supplies funding for the account. In the notification message for the primary user, a user alias ID associated with the account can be that of the primary user. Additionally, a primary card alias ID associated with the account can be that of the primary user. In other embodiments, in the notification message for the joint user(s), the user alias ID is that of the joint user, and the primary card alias ID is that of the primary user.

In certain embodiments, if a declined transaction trigger is accompanied by a declined transaction fee, such as from the issuer, transaction processing network and/or merchant, which changes the available balance on the account through an automatic deduction, only one notification message is sent for the event. The notification message can indicate the available balance change and include the usage details defined by the client for the available balance change trigger. This notification message can include information about the declined transaction and fee. The notification message for the declined transaction trigger can also include the balance change and transaction usage as configured by the client for this trigger. As with other notification messages, the decline transaction notification message is communicated to the client using a first format, such as ISO 0600 protocols and the processor interfaces as described with respect to FIG. 1.

Another trigger can include a maintenance function. Clients may be able to configure the maintenance function trigger for near real-time updates of any occurrence of a defined maintenance functions for an account. When a maintenance function trigger has been activated, the account processing system 228 can create and send a notification message for each select maintenance function occurring on the account. An exception occurs when the client control for the maintenance function trigger setting is set to “Yes” and the accountholder profile control setting is set to “Off”. The aforementioned account state exception is described further in the following paragraphs with reference to FIG. 3.

In exemplary embodiments, a maintenance function can include : an update to a password on the account, an update to a funding option for the account, e.g., a credit card or other account associated with the account, a personal identification number (PIN) change, a failed/successful password change attempt, payment card update, account statement changes, account information update, profile type update, added profile, account profile update, added text subscription, bill pay status update, funds transfer account updates, email notification update, scheduled transfer update, or a convenience check status update. The account processing system can activate one or more triggers in addition to the maintenance function trigger. A separate notification message for each of the different triggers can be sent. Additionally, if multiple maintenance triggers are activated within proximity to one another, a single notification message indicating a current account status reflecting those maintenance function changes can be sent.

The notification message for a maintenance function can include the maintenance function usage as configured by the client for the maintenance function trigger. Additionally, if the account is in an exception status for the status/state change trigger, no notification message is sent for a maintenance function trigger in an embodiment. In other embodiments, the client can configure certain notification messages to be sent when in an exception status.

Another trigger can include a status or state change to the account. Each type of change can generate a different type of notification message and can activate a different trigger type, though both are discussed under a singular trigger type. The notification message(s) for the status/state change trigger can include the status/state change usage defined by the client.

During a status change, the account processing system creates and sends a notification message for any change in an eligible status of a payment card associated with an account on the client system. The trigger can include a payment card being created with an eligible status, except when the trigger clienet control setting for the status/state change trigger is set to “Yes”, the accountholder profile control setting is set to “Off”, or for some exception statuses.

As previously mentioned, for a status change, certain exception statuses can determine whether a notification message is sent or not. For certain exception statuses, the creation of or the change to particular statuses may not activate a status change trigger, e.g., the event does not cause the status change trigger to generate a notification message. The status changes included in the exception statuses, which are often less time sensitive, can be provided to the client through daily batch file. Some exemplary status changes to a payment card which can cause a notification message to be sent, or can be considered an exception, include: pending issuance, issued, stale, pending destruction, destroyed, damaged, void, or further research required.

With regard to a state change trigger, the account processing system can create and send a notification message for any change in the following exemplary state changes: fraud block (e.g., account compromised/stolen), card registered (e.g., activated), deceased accountholder (e.g., account terminated), alternate funding approved, and Falcon block.

In some embodiments, a state change can occur when an exception status is in effect. This results in a state change when in an exception status. When this occurs, no notification message is sent. Accordingly, when a payment card is in an exception status (e.g., a status excluded from the trigger), changes in a payment card state do not activate the state/status change trigger.

A further trigger can be a user-initiated trigger, such as a profile change on the account, e.g., an update to the accountholder's identifying information. Accordingly, clients can configure the profile change trigger for near real-time updates for any change in Profile Data for an account (e.g., address change). When a profile change trigger is activated, the account processing system creates and sends a notification message with current profile data when a change to the Profile has occurred, except when the trigger user profile control setting for the profile change trigger is set to “Yes” and the accountholder profile control setting is set to “Off.” The control settings for each trigger and the configuration of those settings are further described in the following paragraphs with reference to FIG. 3.

In some embodiments, if two or more profile changes occur in close proximity, and for which the system has not already sent a notification message, the system can send only one notification message, with the most current profile data included. Some exemplary events for which a profile change trigger is activated can include a change to one or more of the following fields within an accountholder profile: Legal First Name, Middle Name, Legal Last Name, Suffix, Title, Government ID Type, Government Issued ID, Drivers License State, Passport Country of Issuance, Birth Date, Address1, Address2, City, State, Zip, Country, Primary Phone Number, Primary Phone Number Type, E-mail Address, Text Message Device ID (e.g., cellular phone number).

In certain embodiments of the invention, an event in the account processing system can activate one or more triggers in addition to another trigger. In some embodiments, a separate notification message for each of the different triggers can be sent. In other embodiments, the notification messages can be combined if several triggers are activated within close proximity to another.

In all of the aforementioned triggers, if an event occurs which activates a trigger, but the account is in an exception status, e.g., suspended, no notification message is sent for the trigger(s) activated by that event. An exception status can include a status that is excluded from the previously described status and state change trigger. The notification message for the particular trigger type can include the trigger usage as configured by the client for that trigger type. The notification message can be communicated to the client using ISO 0600 protocols with the core 100 and the processor interface 108 as shown in FIG. 1.

All of the aforementioned actions defining each trigger can be considered an event occurring on the account. Events can also be referred to as a transaction. Transactions can be either financial or non-financial, but cause a change in the current state, e.g., the stored information or record, of the account on the account database.

Referring again to FIG. 3, after an accountholder is registered on the account processing database and with the client system and the triggers are configured, e.g., enabled 300, on the account processing system, various control settings are also configured on the account processing system. The configuration of the control settings occurs prior to enabling a trigger for an account. Two real time account communication trigger controls govern whether notification messages are created and sent based on a particular trigger configuration.

The first trigger control, a client control 302 includes a setting at the client level having valid values, e.g., “Yes” and “No”. The setting uses the binary values of “Yes” and “No” and controls whether the account processor system uses the accountholder “On/Off” control setting value to determine when messages are sent. As previously mentioned, the default value for this control setting is “No” or “Control Not Set”. If the control setting is set to “Yes,” the account processing system then checks the secondary, client control 306 to determine if the accountholder has chosen to “opt in” or “opt out” of a notification message. If the control setting is set to “No” or “Control Not Set”, notification messages for the trigger 300 for which the control settings are being configured are forwarded for all accountholders 304.

The second trigger control, an accountholder profile control 306, includes a setting to control whether an opt-in capability is enabled, e.g., “On” or “Off.” This setting defaults to a “Control Not Set” or “Off” value. If the setting is in default, in some embodiments, the client can generate a message to the accountholder to request the accountholder to configure the setting, e.g., opt-in or opt-out. If the setting is set to “On” 310, the accountholder has elected to receive notification messages for his/her account and the account processing system forwards notification messages to the client for that accountholder account if the client control setting is set to “Yes.” However, if the client control setting is set to “No”, the account processing system does not check an individual accountholder profile control setting, which causes all accountholders, or cardholders, to receive all notification messages 308 for the particular trigger 300 for which the client control settings are being configured. Once the client control setting 302 is turned “On”, the authorization processing system can then involve the next step 306 to confirm an “opt-in” (e.g., “On” setting) for all configured notification messages to be sent to the client for a particular accountholder account. For example, if the “opt-in” setting is set to “On” and the client control setting is set to “Yes”, the notification messages are sent to an accountholder 310 for the trigger 300. If the “opt-in” is set to “No” 308 and the client control setting is set to “Yes”, the account processing system does not send the notification message for the trigger being configured to the client for that accountholder account.

An exemplary embodiment providing the use of the control settings previously described are maintenance function alerts in a client system where accountholders “opt-in” to alerts. In such an embodiment, the client system configures the client control for the maintenance function trigger as “Yes.” This configuration causes the account processing system to check whether the accountholder selected to “Opt-In” to that trigger, e.g., during registration with the client system, before sending a notification message to the client system. In an embodiment, the settings may be configured through a web-based service.

Clients are also able to configure a message type for each trigger. A message type can be configured at the client level and inherited at the sub-client level, unless overridden at the sub-client level. Some exemplary message types can include ISO messages, MQ messages, SOAP message and other network based messaging protocols, which can be utilized in near real time across the transaction processing network. Embodiments of the invention are directed to ISO type messages, particularly ISO 8583 standard 0600 message type. Accordingly, in some embodiments, the ISO 0600 can be the default value for the notification message type.

In addition to message type configurability, clients are able to configure the usage for each message type, as previously mentioned. The usage can be, for example, defined up to a threshold, such as ninety-nine (99) usages. Specific usages can be configured at a card program level for accounts associated with a payment card issued by an issuer and managed by the client system. The usage configuration can be inherited at the sub-client level, unless overridden at the sub-client level. Every trigger and message type can have a usage configured by the client. However, in some embodiments, the available balance change and transaction usage can be configured for the available balance change trigger and for the declined transaction trigger. For example usages can include: available balance change and transaction, maintenance function, status or state change, and profile change.

Usages in accordance with embodiments of the invention can include specific data fields, each having variable character lengths, which are sent in the notification messages for each trigger type. The data fields can include the aforementioned primary accountholder card alias ID, the accountholder alias ID, a transaction category, a transaction type, a card number, a branch (e.g., issuer) identifier, a sub-client identifier, card program ID, merchant information (name, address, number, etc.), sender information (name, address, reference number, account number, etc.), surcharges and fees, transaction amount, transaction date, activation date, expiration date, issuance type/date, and other transaction data which can be associated with particular trigger types.

Clients can also configure and endpoint for receiving the notification messages at the Card Program level, e.g. at the client. The configuration can be inherited by all sub-clients unless overridden. However, endpoint configuration can be overridden at the sub-client level. There can be only one defined endpoint for each card program (client) and sub-client.

Separate clients may configure the same trigger, notification message type, usage, and endpoint. Clients can differentiate between incoming notification messages to the same endpoint by the card program and sub-client values present in each usage. However, a rule can be implemented to prohibit clients from configuring duplicate notification messages (i.e., the same combination of a trigger, message type, usage, and endpoint).

In additional embodiments, clients are able to configure an available balance trigger threshold value for the available balance change trigger such that the trigger only activates or sends a notification message if a change to the balance produces a resulting available balance less than or equal to the configured threshold (e.g., 99). If the client does not configure a value for the available balance change threshold, any change in the available balance can activate the trigger, regardless of the resulting value of the available balance.

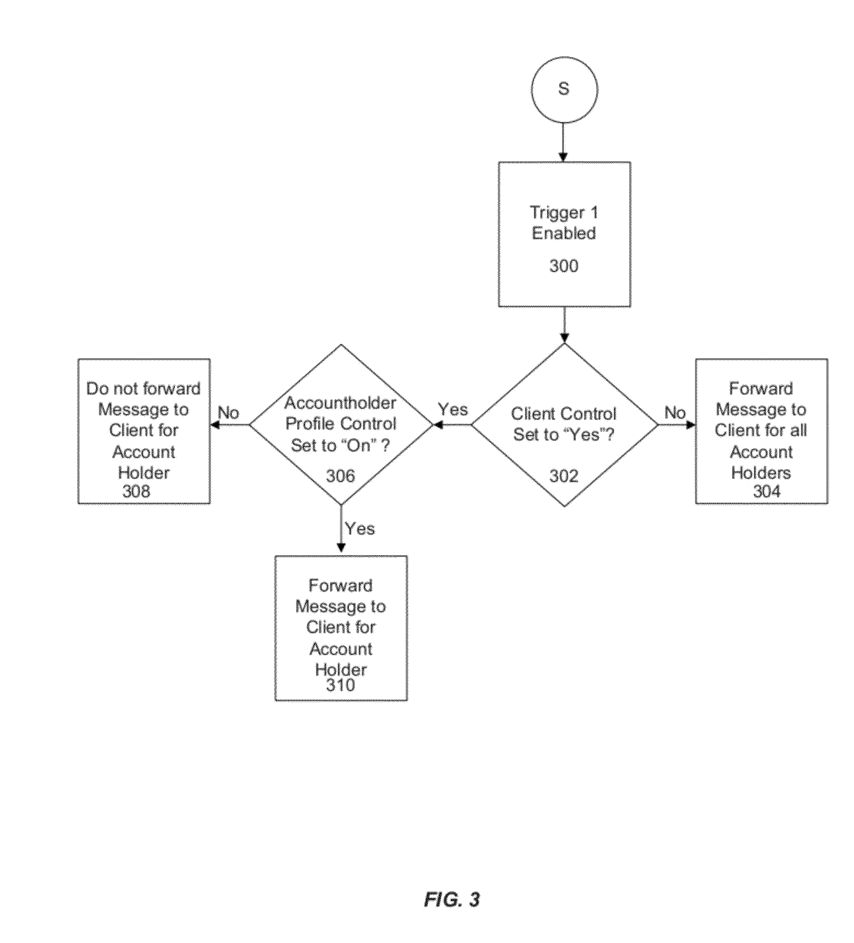

Referring now to FIG. 4, an exemplary screenshot of a sample report 400 indicating the numbers of trigger specific notification messages sent on the authorization processing system is shown. Reports reflecting the number of notification messages sent for a specific client can also been generated at both the account processing system and client-side, based on the trigger type or event in some embodiments. The reports can provide both a numerical listing, e.g., in a chart, of the summarized notification messages/events occurring on the system in an allotted time period and/or a graphical representation of the overall message volume generated on the account processing system or for a specific client. In some embodiments, a client, e.g., through configuration of specific trigger types, can determine which information is provided in a report. In other embodiments, the account processor can determine which information to provide in the report, and can have default trigger types to include in the report 400.

As shown at the top of the page on the sample report 400, both internal and external users of the account processing system may be able to select a card program 401 and location 402. The card program can be a value selected for specific account type stored on the account database for which transactions are processed. Each card program 401 can be managed by a specific client of the account processor. The location 402 option can include all valid locations in which a card program can be implemented as well as an “All” selection to include all locations 402.

To isolate specific information in the report 400, users can select options on the report graphical user interface (GUI) to limit data within a card program 401 or sub-client to a specific trigger configured for that program or sub-client. This can be accomplished using a drop-down selection box in the report parameters. The triggers selection 403 can include all triggers configured for a particular client, or card program 401 and sub-client registered with the account processing system. Additionally, the drop-down selection box can include a selection for “All” triggers to be included in the report. Accordingly, some exemplary valid trigger selections can include: All, Available Balance Change. Status/State Change, Transaction without Available Balance Change, and Profile Change.

Access to a newly generated report can be controlled via a separate security function which can be created for the report 400, e.g., when a first user only wishes himself or other specified users to be able to view the report. The security function default can be set to ‘not visible’, such that reports are all on visible to those granted access to them. In further embodiments, the reports can be generated in various export formats 404, which are selected by a user running the report. For example, the report parameters can provide selection to a user for the report to be generated in XML, CSV Acrobat PDF, MHTML, Excel, TIFF, Word and any other format capable of supporting and displaying the report data.

Reports can include report data 405, which can be displayed at the top of the report: Client, Card Program, Location, Trigger, Run Date, Date Range, Time Frame, User ID, and Page. The report data can include additional report information and is not limited to only the aforementioned items. The report data is a summarized version of the details utilized to generate the report. The report can also include a chart, having columns listing the trigger type being analyzed for the report and the numerical representation of the messages sent for that particular trigger type. Though the display of the aforementioned report information is described in a particular manner, any type of user-friendly graphical user interface can be utilized to display the report 400.

The messages sent count can be a count of all ISO 0600 messages sent to the incoming interface processor, or gateway. ISO 0601 repeat messages, such as those sent to the client repeatedly, such as those sent in the absence of a confirmation response message, are not counted. In further embodiments, for reports with more than one trigger selected for display, the report can display a “Total Notification Message Count,” which may be a sum of the counts for the individual triggers selected for the report.

As previously mentioned, the report can provide a graphical representation of the notification messages generated for a particular card program over a time period. The graphical representation can be utilized to display the data covering more than one day, e.g., notification message volume over time, using volume counts from each day and displaying this in a graph (e.g., line graph). In further embodiments, various other graphical representations displaying analytics of the notification messages sent over a time period, dependent on selected criteria, can be provided within the graphical user interface.

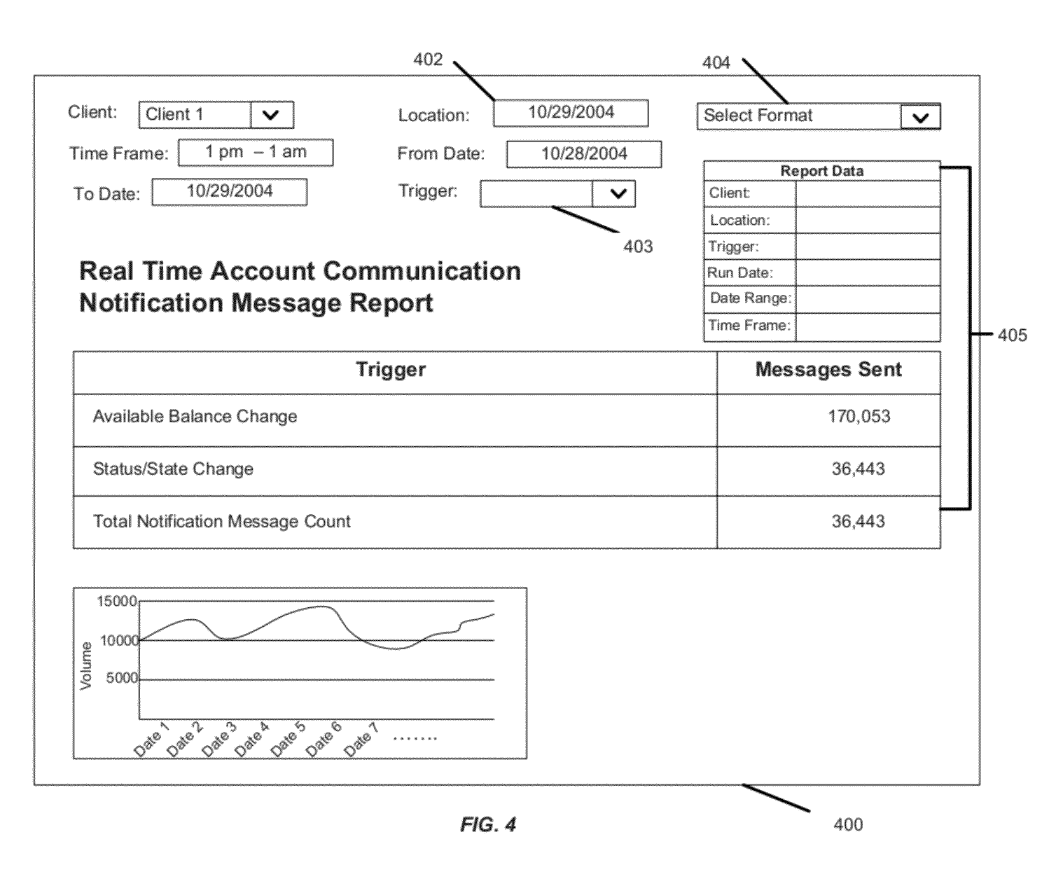

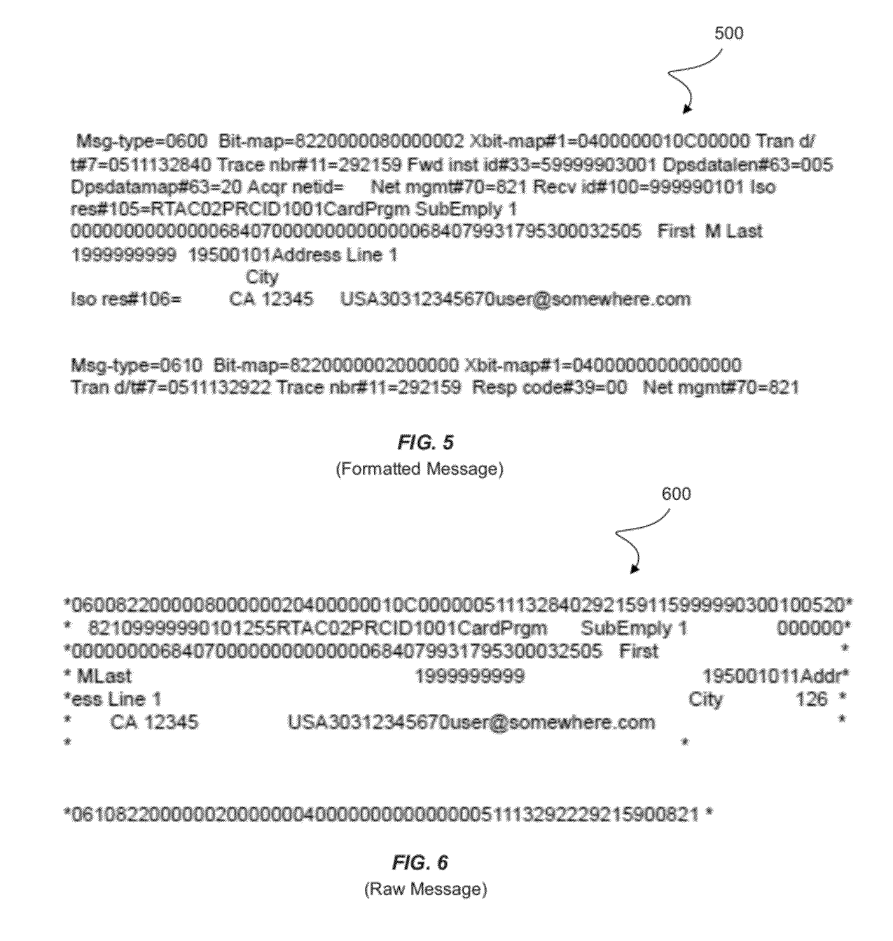

Referring now to FIGS. 5 and 6, an exemplary ISO 0600 notification message, which can be sent to a client and/or to the authorization processing system is shown. Each notification message format is dependent on various configuration choices made during the processor interlace set-up and can include dynamic versus fixed format messaging, character set (e.g., ASCII or other), packed versus unpacked numerics, and type of bit maps (e.g., hexadecimal or other).

As shown within FIG. 5, a standard dynamic ISO formatted notification message using ASCII character set, unpacked numerics, and HEX bit maps is provided. The various data fields within the notification message can include code defining the specific parts of the message. The exemplary message 500 is for an accountholder profile change. For example, as shown in message 500, data fields indicating the message format (“Msg-type=600”), the primary bit map fields (1-64) being sent (“bit-map”), the secondary bit map fields (65-128) being sent (xbit-map#1), and the transmission date and time (“Tran d/t#7”). The message 500 further can include the system trace audit number (“trace nbr#11”) data field, which is the number assigned by the message initiator to uniquely identify a transaction. The message 500 also includes: the forwarding institution ID (“fwd instid#33”), the private defined data (“dpsdatalen#63”), the byte map for sub-elements (dpsdatamap#63), the network ID code (“Acq netid”), the network management code (“net mgmt#70”), the receiving institution ID code (“Rec id #”), and the large private data (Iso res#105). The large private data can be an open field, which contains account processor data previously described in the usage types.

Still referring to the formatted notification message 500 in FIG. 5, the “First M Last 199999999”, “Address Line 1”, “City”, “Iso res#106 ” and email address (e.g., USA303 123 . . . @ somewhere.com) can reflect the actual profile change entered by the accountholder. As described in previous sections, each notification message can include a request that a confirmation message be sent in response. The notification message can be continually sent to the client until the confirmation is received. The last two lines of the formatted message in FIG. 5 can reflect t the response message from the client, confirming receipt of the notification message. The confirmation response message can include data fields indicating the message type (“msg-type=0610). The ISO 0610 message type is an administrative response message. The confirmation response message can further include data fields for the primary bit-map (“bit-map”), the secondary bit-map (xbit-map#1), the transmission date and time (“tran d/t#7), the transaction ID, or system trace audit number “trace nbr#11”), the response code indicating whether the message was correctly received (“resp code#39) and the network management code (“net mgmt#70”).

Referring now to FIG. 6, the same information contained with notification message 500 of FIG. 5 is shown in a raw format message 600, without any data field names indicated. The raw message formatted message 600 can be the actual notification message and response message sent between the client system and the authorization processing system.

Exemplary Methods

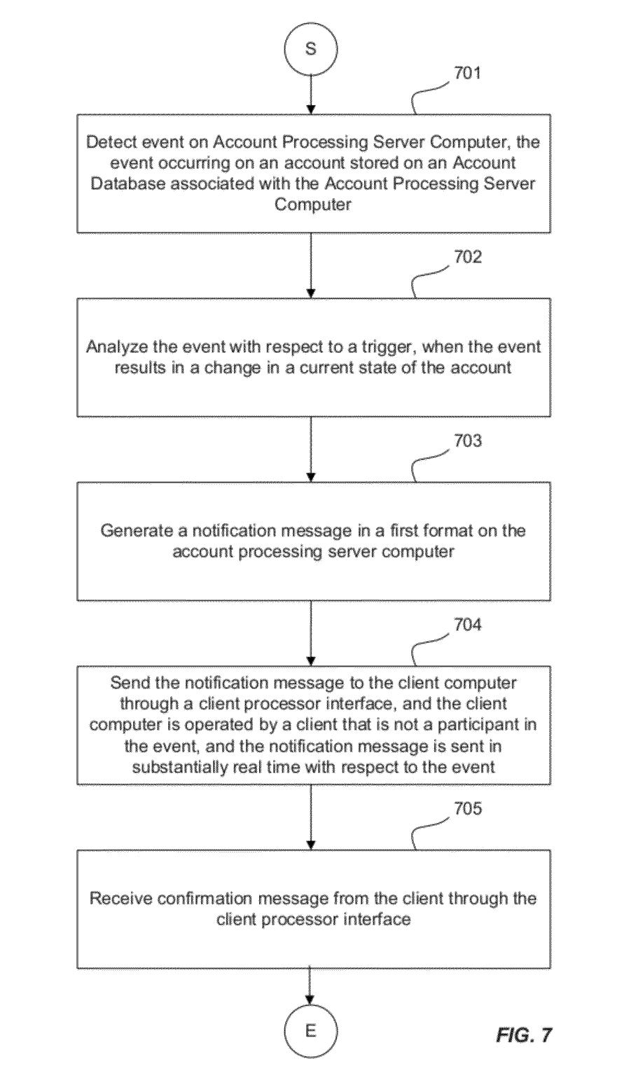

Exemplary method implementing the near real time account communication between the authorization processing system and a client system are described with reference to FIG. 7. FIG. 7 describes a method 700 for providing a notification message to a client system in response to a triggered event being detected on the account processing system.

Referring now to FIG. 7, a method is shown for providing real time account communication to a client, such as to a client computer. Method 700 is described with reference to the elements in FIG. 2A and FIG. 2B, and can occur in response to a transaction being conducted on an account registered within the account processing system 228.

In step 701, the account processing system 228 detects an event occurring on an account stored within the account database 232. The event can be detected on the account processing server computer, which receives and sends messages on the account processing system 228 through a processor interface 236, which formats the messages according to a specified configuration. The event can be defined as a transaction, such as the accountholder 200 conducting a transaction with a payment card associated with the account at a merchant location 202. An authorization request message, including the transaction details, can be sent to an acquirer server computer 218 and forwarded to the transaction processing network (core) 204 for further processing. The core 204 can additionally send the transaction details and account information to the account processing server computer 230, to detect the transaction as an event on the associated account.

As previously discussed, the account can be checked against the account database 232 to determine if the account is registered and qualifies to generate notification messages for a client system. In some embodiments, the transactions details and/or the account information included in the transaction details can include data, e.g., in a data field, indicating the account enrollment with the account processing system, such that the transaction is identified on the transaction processing network 204 as a registered account on the account database 232.

Next, in step 702, the event, e.g., the transaction details, can be analyzed by the account processing server computer with respect to pre-configured triggers associated with a client managing that particular account. The client can be a card program management system, such as for a particular payment card, e.g., debit or prepaid card, issued to an accountholder. If the event is analyzed and it is determined that there is no trigger satisfying the event, no further action is taken on the account and the account information can be updated within the account database 232 with respect to the transaction details. The events can be included in a daily batch report provided to the client, as is known within the art.

If the event results in a change in the current state of the account and satisfies a trigger configured by the client on the account processing system 228, the account can be further processed by the account processor and the trigger which applies to that particular event can cause a notification message to be formed. The notification message can be formatted in a way defined in the configuration settings for the particular trigger that it satisfies. Additionally, the notification message can include the usages defined for that particular trigger.

In step 703, the notification message is generated on the account processing server computer 230. The notification message can include the event details indicating the change in the current state of the account, and can be formatted in a first format defined within the configuration settings set by the client and/or account processor. As mentioned previously, the notification message can include the data fields defined for the usages of a trigger type activated by the event. In some embodiments, the event qualifies under more than one trigger type, and can cause a combined notification message to be sent to the client or multiple notification messages to be sent to the client computer 210, 212, 214 in response to the event.

In step 704, the notification message is sent to the client, e.g., to a client computer, through the client processor interface 208. The notification message can be in ISO 0600 format and can include the account information, updates (if any) and transaction details activating the trigger on the account processing system 228. the data included within the notification can be determined by the client system during the registration process and can include various data fields associated with the account and the event type. The client processor interface 208 can be capable of receiving and reformatting the message into a second format, which can be readable by the client computer 210, 212, 214.

The client computer is operated by the client and can be part of a larger client system, e.g., having an account database and server computer, etc. The client is not a participant in the event, e.g., the client is not a participant in the transaction or the transaction processing. Thus, the client can act as a third party, which receives notification messages in response to a transaction occurring separate from that third party. For example, an accountholder 200 can conduct a transaction at a merchant 202 to purchase a good for sale. The transaction can be processed, cleared and settled similar to a regular transaction known in the art, through an acquirer 218, a payment processing network or core 204 and issuer 216. However, the transaction details specific to triggers defined on the account processing system 228 and the account information and changes can also be provided, after the transaction is conducted, to any number of client computers in client systems, which can utilize the account information and transaction details to perform any number of functions. Some exemplary functions can include providing alerts to an accountholder dependent on the current state of the account, conducting “off-line” transactions on the account, and/or tracking usage patterns on the account for reporting purposes.

The account processing server computer 230 can receive the notification message from the account processor server computer 230 in near real time, e.g., the notification message is sent from the account processing server computer 230 in substantially real time with respect to the event occurring.

Finally, in step 705, the account processing system 228 can receive a confirmation response message, confirming the receipt of the notification message on the client computer 210, 212, 214. The confirmation message can also be in the first format, e.g., the ISO 8583 format, which was utilized for the notification message. The confirmation response message can be received through the processor interface 236 communicatively coupled to the account processing system 228. If no confirmation response message is received from the client computer to which the notification message was sent, the account processing server computer 230 can continue to send the notification message to the client computer 210, 212, 214 until confirmation is received. In some embodiments, the session can time out after a certain threshold number of attempts to send the notification message has been met or after a certain allotted time period has passed. In an embodiment where multiple notification messages are generated and sent in response to a single event occurring, multiple confirmation response messages are also received from the client computer. In further embodiments, if multiple notification messages are received at substantially the same time, the client processor interface can provide a single response message to the account processing server computer, which identifies each notification message ID for which the confirmation response is being sent.

In other embodiments, a method can be provided for utilizing the updated account information on the client system to perform a subsequent event on the account, such as generating an alert message to an accountholder or conducting an offline transaction on the account. The method can include receive a notification message from an account processing server computer for an account, storing information including account details, current state of the account and a last event occurring on the account in a client database. The method can further include detecting transaction being conducted by an accountholder of the account with the client and determining the current state of the account on client database. The method can also include processing the transaction offline based on current state of account stored in client database, generating an alert message indicating approval or denial of transaction in a second format, and sending the alert message in the second format to the accountholder.

In other embodiments, a method for conducting an off-line transaction in real-time is provided. The method can include detecting a transaction being conducted on an account with a client on a computer, determining a current state of the account based account information on the client database, processing the transaction off-line based on the determined current state of the account, generating an alert message, and sending the alert message to an accountholder device associated with the account. In some embodiments, the account information for the account is stored on a client database associated with the client. In other embodiments, the alert message indicates approval or denial of the transaction. In yet another embodiment, the alert message is in a second format, which differs from the first format.

Exemplary Computer Apparatuses

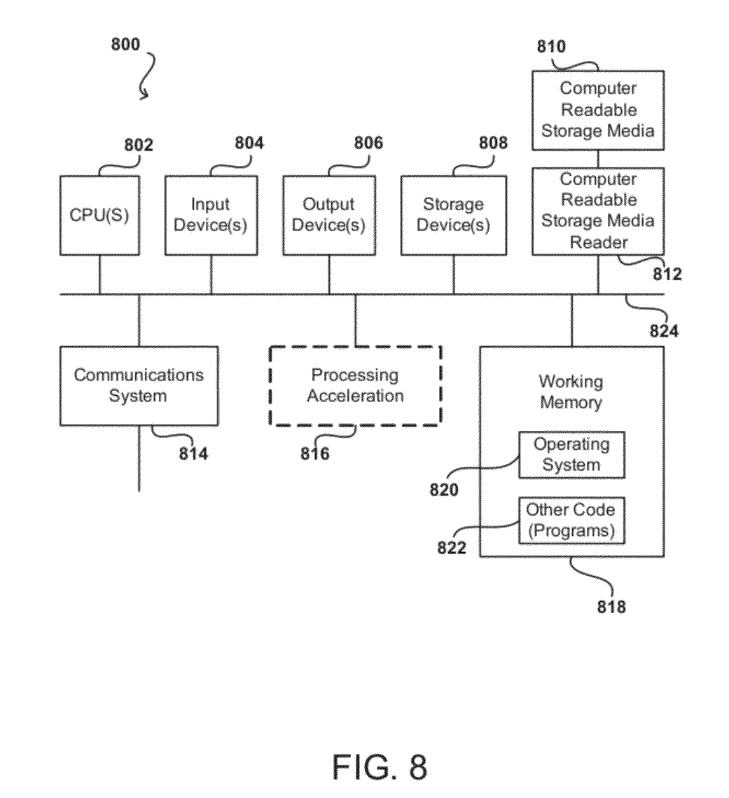

Exemplary computer apparatuses are described with reference to FIG. 8. In particular, an exemplary computer system 800, such as that utilized for a central processing server, a client computer, e.g., for user enrollment and/or online transactions, and/or a merchant register, is illustrated in FIG. 8. The computer system is configured to execute computer readable code to implement various functions and steps according to various embodiments of the present invention.

The computer system 800 is representative of a computer system capable of embodying the present invention. The computer system 80 can be present in any of the elements in FIGS. 1, 2A and 2B, including the computer(s) operating the account processing system, as described above. It will be readily apparent to one of ordinary skill in the art that many other hardware and software configurations are suitable for use with the present invention. For example, the computer system 800 may be a desktop, portable, and rack-mounted or tablet configuration. Additionally, the computer system 800 may be a series of networked computers. Further, the use of other micro-processors are contemplated, such as Xeon™, Pentium™ or Core™ microprocessors; Turion™ 64, Opteron™ or Athlon™ microprocessors from Advanced Micro Devices, Inc; and the like. Further, other types of operating systems are contemplated, such as Windows®, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board. Various embodiments may be based upon systems provided by daVinci, Pandora, Silicon Color, or other vendors.

In one embodiment, computer system 800 typically includes output devices 806 (e.g., display), input devices 804, communications interfaces 88, one or more central processing units (CPUs) 802, a working memory 818, computer readable storage media 810 and media reader 812, and one or more storage devices 808. In various embodiments, display (monitor) may be embodied as a CRT display, an LCD display, a plasma display, a direct-projection or rear-projection DLP, a micro-display, or the like. In various embodiments, the display may be used to display user interfaces and rendered images.

In various embodiments, a user input devices 804 are typically embodied as a computer mouse, a trackball, a track pad, a joystick, wireless remote, drawing tablet, voice command system, and the like. User input device 804 typically allows a user to select objects, icons, text and the like that appear on the display via a command such as a click of a button or the like. An additional specialized user input device, such a magnetic stripe, RFID transceiver or smart card reader may also be provided in various embodiments. In other embodiments, user input devices 804 include additional computer system displays (e.g. multiple monitors). Further user input devices 804 may be implemented as one or more graphical user interfaces on such a display.

Embodiments of communication systems 814 typically include interfaces such as an Ethernet card, a modem (telephone, satellite, cable, ISDN), (asynchronous) digital subscriber line (DSL) unit, FireWire interface, USB interface, and the like. For example, communication interfaces 88 may be coupled to a computer network, to a FireWire bus, or the like. In other embodiments, communications systems 814 may be physically integrated on the motherboard of the computer system 800, may be a software program, such as soft DSL, or the like.

RAM and disk drive are examples of tangible computer readable storage media 810 configured to store data such user data, account data, merchant data, third-party service provider data, payment network data, abstraction layer databases and look-up tables and other executable computer code, human readable code, or the like. Other types of tangible computer readable storage media 81 include magnetic storage media such as floppy disks, networked hard disks, or removable hard disks; optical storage media such as CD-ROMS, DVDs, holographic memories, or bar codes; semiconductor media such as flash memories, read-only-memories (ROMS); battery-backed volatile memories; networked storage devices, and the like. The computer system 800, can include a computer readable storage media reader 812, such as a hard, floppy or optical disk drive, or universal serial bus port capable of reading the computer readable storage media 810.

In the present embodiment, computer system 800 may also include software that enables communications over a network such as the HTTP, TCP/IP, RTP/RTSP protocols, and the like. In alternative embodiments of the present invention, other communications software and transfer protocols may also be used, for example IPX, UDP or the like.

In various embodiments, computer system 800 typically includes familiar computer components such as a processor, e.g., CPUs 802, and memory storage devices 808, such as a random access memory (RAM), disk drives, and system bus 824 interconnecting the above components. The computer system 800 can also include a working memory 818, e.g., RAM, EEPROM, ROM, which stores computer readable instructions executable by the processor, such as the operating system 820 and application program software, or computer executable code 822.

In some embodiments, the computer system 800 includes one or more Xeon microprocessors from Intel. Further, in the present embodiment, the computer system 800 typically includes a UNIX-based operating system.

Embodiments of the invention are not limited to the above-described embodiments. For example, although separate functional blocks are shown for an issuer, payment processing network, and acquirer, some entities perform all of these functions and may be included in embodiments of invention.

Specific details regarding some of the above-described aspects are provided above. The specific details of the specific aspects may be combined in any suitable manner without departing from the spirit and scope of embodiments of the invention. For example, back end processing, data analysis, data collection, and other transactions may all be combined in some embodiments of the invention. However, other embodiments of the invention may be directed to specific embodiments relating to each individual aspect, or specific combinations of these individual aspects.

It should be understood that the present invention as described above can be implemented in the form of control logic using computer software (stored in a tangible physical medium) in a modular or integrated manner. Based on the disclosure and teachings provided herein, a person of ordinary skill in the art will know and appreciate other ways and/or methods to implement the present invention using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method for providing real time account communication to a client computer, the method comprising:
detecting, on an account processing server computer, an event occurring on an account within an account database;
analyzing the event with respect to a trigger, wherein the event results in a change in a current state of the account;
generating, by the account processing server computer, a notification message in a first format; and
sending the notification message to the client computer through a client processor interface,
wherein the client computer is operated by a client that is not a participant in the event, and the notification message is sent in substantially real time with respect to the event.

2. The method of claim 1, wherein the first format defines a message type having a particular structure.

3. The method of claim 1, wherein the notification message is in ISO 8583 format.

4. The method of claim 1, wherein the notification message includes a plurality of data fields, and wherein a specific data field is paired with the trigger dependent on a trigger type.

5. The method of claim 1, wherein the event occurs in response to a financial transaction being conducting on the account.

6. The method of claim 5, wherein the trigger includes a change in the balance within the account.

7. The method of claim 5, wherein the trigger includes a declined transaction.

8. The method of claim 1, wherein the event occurs in response to a non-financial transaction on the account.

9. The method of claim 8, wherein the trigger includes any one or more of a change to a current status of the account, an update to a user profile on the account, or a maintenance function performed on the account.

10. The method of claim 1, further comprising receiving a first communication from the client computer wherein the first communication includes the event.

11. The method of claim 1, wherein the notification message includes account information with details relating to the event and to the current state of the account.

12. The method of claim 11, wherein the client computer stores the account information in a client account database and utilizes the stored account information to conduct an off-line transaction on the account.

13. The method of claim 1, wherein the client computer utilizes the stored account information on the client account database to generate an alert for a user associated with the account.

14. The method of claim 1, further comprising receiving, at the account processing server computer, a confirmation message from the client computer, wherein the confirmation message is sent through the client processor interface.

15. An account processing server computer comprising:
a processor; and
a computer readable medium coupled to the processor, the computer readable medium comprising code executable by a processor for implementing a method comprising:
detecting, on an account processing server computer, an event occurring on an account within an account database;
analyzing the event with respect to a trigger, wherein the event results in a change in a current state of the account;
generating, by the account processing server computer, a notification message in a first format; and
sending the notification message to a client computer through a client processor interface,
wherein the client computer is operated by a client that is not a participant in the event, and the notification message is sent in substantially real-time with respect to the event.

16. The server computer of claim 15, wherein the notification message includes a plurality of data fields, and wherein a specific data field is paired with the trigger dependent on the trigger type.

17. The server computer of claim 15, wherein the first format defines a message type having a particular structure.

18. The server computer of claim 15, wherein the notification message is in ISO 8583 format.

19. The server computer of claim 15, further comprising receiving, at the account processing server computer, a confirmation message from the client computer, wherein the confirmation message is sent through the client processor interface.

20. The server computer of claim 15, wherein the notification message includes account information with details relating to the event and to the current state of the account.

21. The server computer of claim 15, wherein the client computer stores the account information in a client account database and utilizes the stored account information to conduct an off-line transaction on the account.

22. The server computer of claim 15, wherein the client computer utilizes the stored account information on the client account database to generate an alert for a user associated with the account.
